(19) United States
(12) Patent Application Publication
(10) Pub. No.: US 2026/0350047 A1
(43) Pub. Date: Nov. 5, 2026

(54) AGENTIC ARCHITECTURE FOR ARTIFICIAL INTELLIGENCE CHATBOT SYSTEMS

(71) Applicant: MicroStrategy Incorporated, Vienna, VA (US)

(72) Inventors: Roberto Lara, Vienna, VA (US); Matias Ravizzoli, Vienna, VA (US); Hariganesh Srinivasan, Vienna, VA (US); Rakshit Sinha, Vienna, VA (US); Veronica Cao, Vienna, VA (US); Justin Shin, Vienna, VA (US)

(21) Appl. No.: 19/464,202

(22) Filed: Jan. 29, 2026

Related U.S. Application Data
(60) Provisional application No. 63/799,272, filed on May 2, 2025.

(51) Int. Cl. G06F 16/332; G06F 16/334

(52) U.S. Cl. CPC G06F 16/3325; G06F 16/334

(57) ABSTRACT

Methods, systems, and apparatus, including computer-readable media, for an agentic architecture for artificial intelligence chatbot systems. In some implementations, a system receives text input from a user, and in response, the system processes the text input using a set of multiple processing actions that each involve processing by one or more artificial intelligence and/or machine learning (AI/ML) models. The set of multiple processing actions includes actions such as generating an augmented text input, identifying one or more data objects of a data set, generating code or instructions for retrieving data from a data set, and generating output based on the augmented text input and data retrieved from the data set. The system sends the generated output as a response to the text input.

### TECHNICAL FIELD

This application claims priority to U.S. Provisional Patent Application No. 63/799,272, filed on May 2, 2025, the entire contents of which is incorporated by reference herein.

### TECHNICAL FIELD

The present specification relates to techniques for an agentic architecture for chatbot systems that leverage artificial intelligence and/or machine learning.

### BACKGROUND

Chatbots that leverage large language models (LLMs) can respond to user prompts (e.g., user inputs such as questions) in text-based messaging sessions or conversations with users. Training the most capable models typically requires a very large amount of training data as well as large amounts of computing power and time. In addition, many chatbots lack accuracy in interpreting user prompts and obtaining relevant results, especially from large or complex data sets.

### SUMMARY

In some implementations, a computer system provides chatbot capabilities using an agentic architecture that can leverage artificial intelligence and/or machine learning (AI/ML) techniques to respond to a user prompt, such as a natural language query. The agentic architecture can include multiple agents, and each agent is configured to perform a specific task. Agents can perform their respective tasks in conjunction with one or more of AI/ML tools, such as LLMs, vector databases, and so on. By configuring the agents to specialize in performing limited types of tasks (e.g., often a single primary function), each agent can perform its task with high efficiency and high accuracy. The set of specialized agents can perform various different types of tasks that, when taken together, generate highly accurate and relevant responses to user prompts with low latency.

The agents can be invoked in a sequence that provides a workflow that is capable of answering a wide variety of user prompts. In some stages of the workflow, there can be multiple agents that do not rely on each other’s results, and so can perform their processing in parallel to reduce latency. For some other agents, the input to the agent’s processing may be the output of another agent’s processing, so that there is a sequence or dependency in the processing of the agents. In other words, in some cases, the result of one agent’s execution of its task can be provided to another agent or group of agents within the agentic architecture. The ability of the system to allow agents to build on or leverage the knowledge and relationships determined by other agents helps the system achieve better accuracy than many other systems, especially systems that employ an AI model to generate an answer in a single step. Through the connections among agents and the overall workflow of the architecture, the computer system can coordinate the use of the results from each agent in order to generate the response that is output to the user in response to the user prompt.

Another benefit of dividing the overall chatbot architecture into several agents focused on different tasks is that the system can use different AI/ML models (e.g., differently trained LLMs) that are best suited for the task. As an example, a larger more expensive to run LLM can be used for more complex tasks, such as the final synthesis and generation of text or image content. Smaller more specialized models can be used for tasks that involve primarily pattern matching, classification, selection, scoring, or other discrete tasks. The specialized models can be fine-tuned with their own sets of training data, or can simply represent smaller, more efficient generalized LLMs. This allows the system to operate with higher efficiency, which allows for higher throughput and lower latency.

In some implementations, a computer system that uses an agentic architecture can include multiple agents that have, for example, different functions, different inputs, different outputs, different capabilities, different system prompts or system instructions, access to different data types, and/or access to different AI/ML models. The computer system can receive a query and disburse the query to one or more of the agents, each configured to perform respective functions. After the various agents perform their respective functions, the results are then provided to another set of agents to perform their corresponding functions. For instance, a visualization detector agent determines whether the query requests for a specific type of visualization to be produced and a router agent determines a type of prompt (e.g., a category or classification of the query) the user has provided. The visualization detector agent and the router agent propagate their results to an interpreter agent, which can use their results to generate an augmented user input that incorporates additional context (e.g., from the current conversation, from the current data set, from the current task being performed by the user, from the current user interface state, and so on) that aids in later steps where additional agents contribute to generating a response to the query. The computer system can share or propagate results from at least some of the agents to become inputs to subsequent agents in the overall response workflow when those results aid the subsequent agents in performing their respective functions. As discussed below, the sharing of results among agents can be done selectively, so that each agent receives the information needed to perform its function, but extraneous information can be omitted (e.g., masked or not provided to some agents) to avoid inaccuracy. One of the common limitations of LLMs is that they often do not effectively distinguish among content from different sources in their context, and so may give attention to or are affected by any of the information in the context, even when it is not relevant to the current question or task. The present architecture can mitigate this problem by tailoring the context for each agent or task, often removing elements that could be misleading or distracting. For example, after a visualization detector agent identifies keywords related to visualizations, those visualization keywords can be saved and provided to the agents performing visualization-related tasks, while the visualization keywords are removed from the version of the user prompt provided to the other agents performing non-visualization-related tasks. This way, the visualization-specific input elements (or even visualization-related intermediate processing results) are routed to the agents where they are needed and used, and those visualization-specific elements are withheld from the other agents where those elements are not helpful and could degrade the quality or reliability of output for their respective tasks.

The agentic approach can enable the computer system to enhance communications and provide a response to the query in a more efficient manner. For example, various agents can perform processing in parallel, reducing an overall time for the computer system to return a response to the query, and thus providing a low perceived latency to the user. Additionally, because the agents have defined functions and limited inputs, the execution of processing for agents can be very efficient. For example, typically the more information an AI/ML model processes (e.g., the more information is in the context window of an LLM), the longer it takes to complete the processing. In the present architecture, each agent has a limited set of input or context, which allows for fast execution. For example, in some implementations, although at least one agent may process information from the conversation history (e.g., previous user prompts and chatbot responses) most or even all of the other agents are not required to receive and process the conversation history, and can instead focus on performing their respective tasks based on the current user prompt and other agent outputs.

For example, as discussed below, an interpreter agent can process the conversation history (as well as potentially other information) and can output an augmented user prompt that incorporates relevant information from the conversation history. As an example, a user may provide a user prompt that has a pronoun, e.g., “what are its latest sales figures?,” and the interpreter agent can detect the reference and create an augmented prompt that does not require the conversation history to determine the meaning, such as “what are the model X phone’s latest sales figures?” More generally, examples of changes include expanding an acronym, date, or nickname to a more complete full reference, or supplementing an entity name with related information about the entity. The interpreter can also expand or enhance the user prompt with information from knowledge base, based on the state of a user interface of the user (e.g., based on the visual context seen by the user when the text input was submitted), or based on the data set the user is or was working with (e.g., the data context of a database, table, etc. the user is was working with). Creating or using an augmented user prompt in this way improves efficiency by allowing conversation history or other background information to be analyzed once rather than by many different agents, while still providing the relevant information to be used by other agents by incorporating it into the augmented user prompt. It improves reliability by ensuring that other agents that receive the augmented user prompt receive the same set of information from the conversation context, which avoids the risk of different agents potentially interpreting the original prompt in different ways (e.g., a risk that different agents potentially disambiguate a reference in different ways). This also helps increase accuracy by not introducing material from the conversation history that could cause confusion, while also increasing speed due to the small amount of input data or context to be processed by individual agents. When possible, parallelizing the use of at least some of the agents also reduces the overall time for providing a response to the query and enhances overall processing.

Based on user interactions and feedback to the computer system, the agentic approach can facilitate a more natural conversation with a user. For example, an interpreter agent can be configured to evaluate a conversation history of a chatbot session in order to import or retain significant context from a previous conversations in processing of a subsequent query. In this manner, the interpreter agent can provide continuity by maintaining criteria and topic information from one query to the next. This allows for a more natural conversation with a user. For example, the computer system may receive a query from the user that states “Show me financial data for Northeast region in 2024”. The computer system processes this query and returns results to the user. In a subsequent query, the computer system receives a subsequent query that recites “Now show me for 2023”. The user did not specify the same criteria or parameters as the earlier question (e.g., “financial data” for the “Northeast region”), but the conversation context indicates that the user implicitly intends to view that type of data and thus the previous criteria are still relevant. The interpreter agent can process the most recent query, along with previous queries and chatbot responses, to detect the implicit criteria that were not supplied with the current query. For example, for the query “Now show me for 2023,” the interpreter can generate an augmented query with incorporated criteria from earlier in the conversation, “Show me financial data for Northeast region in 2023,” based on the previous query asking for this type of data (e.g., financial data for Northeast region”). This augmented query can be provided to other agents, allowing them to benefit from the context of the conversation without having to process the conversation history.

As discussed below, a chatbot system can be configured to divide processing of a user prompt and generation of a response among multiple agents. Each agent of the multiple agents performs a portion of the processing for responding to the user prompt using artificial intelligence and machine learning models. These agents are assigned different functions or different roles for interpreting and/or processing aspects of the user prompt. Collectively, the agents work together to generate a useful chatbot response to provide to the user.

Each of the agents in the system can have a system prompt that specifies the task or role of the agent and specifies parameters for performing the associated task, such as a desired type of output and the format for that output. The computer system can store predefined system prompts for each of the multiple agents of the chatbot agent, where each system prompt is configured to invoke one or more functions for a corresponding agent. In addition, the system can store, for each agent, data that defines the set of input that each agent receives. The system also stores data that defines the overall pipeline or data flow that governs the invocation of and the interaction of these agents. Upon receiving a user prompt, the system distributes the user prompt to the agents through the pipeline. This flow of data can permit different paths of processing among the agents, and the different paths can be used selectively based on the outputs of the agents and the type of request made by the user. For example, one type of user request may result in processing using all of the agents in a predetermined sequence, while processing for a different type of request may result in a different sequence in the bypassing of some agents that are not needed. Some of the agents are configured to operate in parallel for a user prompt while others operate sequentially, with some agents being invoked after and using the output from processing by another agent. As an example, is that some agents may extract certain types of information from the user prompt, and the other agents may use that extracted information to perform operations according to their assigned functions. In some cases, agents operate in sequence, where the output of one agent is provided as input to one or more other agents.

For example, a first agent can be configured to generate an enhanced or augmented user prompt by processing both the user prompt and a conversation history of the user. Other agents can be configured to identify relevant data objects from a database, where the data objects include metrics, attributes, or other objects. Still other agents can be configured to retrieve information from a database or other data source. Additional agents may be configured to detect a language of the user prompt or detect whether the user prompt contains a request for data visualization. Other agents can be used to generate different types of output content to provided as a response to the user prompt.

In one general aspect, a method performed by one or more computers includes: receiving, by the one or more computers, text input from a user; in response to receiving the text input, processing, by the one or more computers, the text input using a set of multiple processing actions that each involve processing by one or more artificial intelligence and/or machine learning (AI/ML) models, wherein the set of multiple processing actions includes: generating an augmented text input based on additional context for the text input; identifying one or more data objects of a data set based on the augmented text input; generating code or instructions for retrieving data from a data set based on the augmented text input; and generating output based on the augmented text input and data retrieved from the data set using the generated code or instructions; and sending, by the one or more computers, the generated output as a response to the text input.

In some implementations, the method includes providing a chatbot interface, wherein the text input from the user is a user prompt provided through the chatbot interface.

In some implementations, the one or more AI/ML models comprise one or more large language models.

In some implementations, each of the multiple processing actions is performed by a different agent, wherein the agents have different system prompts that direct the agents to respectively perform different tasks.

In some implementations, at least some of the agents are configured to have different output formats or different context for performing their respective tasks.

In some implementations, generating the augmented text input based on additional context for the text input comprises generating the augmented text input based on at least one of: a conversation history for a conversation that includes the text input; a knowledge base for the user or an organization associated with the user; a set of preferences for the user or an interaction history for the user; information in a user interface in which the text input was provided; or one or more entities named in the user prompt.

In some implementations, identifying the one or more data objects comprises identifying, from a set of data objects specified by a data model for the data set, one or more data objects that correspond to one or more terms in the text input.

In some implementations, identifying the one or more data objects comprises evaluating the augmented text input using multiple agents that are each configured to identify different types or categories of data objects, wherein the multiple agents are configured to operate in parallel to with each examining the text input or the enhance text input to detect references to its corresponding type or category of data object.

In some implementations, the method includes, for at least a particular type or category of data objects, performing processing for the augmented text input using multiple instances of the agent for the particular type or category of data objects, wherein the multiple instances of the agent for the particular type or category of data objects operate in parallel to identify data objects of the particular type or category based on the augmented text input; and selecting, for the augmented text input, one or more data objects of the particular type or category based on the output of the multiple instances of the agent for the particular type or category.

In some implementations, generating output based on the augmented text input and data retrieved from the data set using the generated code or instructions comprises: generating output based on the augmented text input and data retrieved from the data set using each of a plurality of agents that are each configured to generate a different type of output content, wherein the agents are configured to operate in parallel to generate output in response to receiving the text input; and combining output of the multiple different agents, such that the generated output provided as the response to the text input comprises generated output from multiple of the plurality of agents.

In some implementations, the groups of agents include a prompt analysis group that includes a first agent configured to detect references to visualizations, a second agent that is configured to classify the text input, and a third agent that is configured to determine a language for a response to the text input.

In some implementations, the groups of agents includes a data object selection group that includes multiple agents configured to determined mappings between terms and data objects in the data set, wherein the multiple agents in the data object selection group include agents configured to map terms to different types of data objects.

In some implementations, the one or more computers are configured to operate multiple instances of at least one agent in the data object selection group in parallel with the same set of input and context, and wherein the one or more computers are configured to generate an output for a type of data object by combining or evaluating the outputs from each of the multiple instances.

In some implementations, the groups of agents includes a data object selection group that includes a first agent configured to map terms to attributes, a second agent configured to map terms to metrics, and a third agent that is configured to map terms to time references.

In some implementations, the groups of agents include a response generation group that includes multiple agents that are configured to generate different types of output content.

In some implementations, the response generation group includes a first agent configured to generate content for data visualizations, a second agent configured to generate a natural language output, and a third agent configured to generate a natural language explanation of analysis steps in generating the response.

In some implementations, the generated code or instructions comprises a SQL statement.

In some implementations, the augmented text input omits one or more terms from the text input.

In some implementations, the method includes removing visualization keywords that are identified in the user prompt, providing the visualization keywords to an agent configured to generate visualization content, and withholding the visualization keywords from one or more agents configured to perform data retrieval.

In some implementations, the method includes determining a classification for the text input; and selectively activating the other agents based on the classification.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system that uses an agentic architecture for artificial intelligence chatbot processing.

FIG. 2 is a diagram showing an architecture of a data processing pipeline interacting with the agents and the AI/ML models.

Like reference numbers and designations in the various drawings indicate like elements.

### DETAILED DESCRIPTION

In some implementations, a computer system can enhance communications using an agentic approach that leverages the cooperation of multiple AI/ML agents. The computer system can utilize many different agents to perform different types of functions in responding to a query (e.g., a user prompt such as a text input from a user). Each agent can be a module (e.g., a software module) that can involve (but is not required to involve) processing by an AI/ML model (e.g., an LLM, a classifier, a neural network, a decision tree) or another type of processing, such as semantic search using a vector database. Various agents can each have different system prompts or system instructions that cause the agents to each perform on a component task of the overall task of responding to a user’s query. The agents work in a coordinated way, with the computer system passing results of agents to other where appropriate for the types of tasks the agents are configured to perform. The computer system uses the agents together to determine a response to the query that is sophisticated and accurate. The data flow or sequence in which agents are connected can be predetermined, using a template or workflow, or can be variable according to the output produced by one or more of the agents. In some cases, multiple templates or workflows can be used for responding to different types of user requests. As another example, within the overall sequence or connection of agents, some agents or groups of agents may be selectively bypassed or skipped when not needed to answer a particular type of request.

An agent can be a small application or module, that is configured to perform a particular type of processing. Agents can optionally be run as separate services, processes, threads, or other units for execution. Each agent can have a defined function or task to perform, particular types of input and/or context to process, and a particular type of output to generate. Many agents perform processing by an AI/ML model, such as an LLM, and these agents can have a predetermined system instruction or system prompt that defines their function. Some agents are connected to one or more datasets or have the capability to send requests to retrieve data from a database system. In general, the computer system can use the agents to retrieve facts and data for answering user questions from reliable sources such as databases or other data sources, which provide accurate and consistent results from a data set (as opposed to the content that is generated based on the training state of an LLM alone). Nevertheless, as discussed before, there can be several significant steps, performed by different agents, to gather the information needed to define the criteria for the data retrieval. In some cases, agents may represent search or data retrieval processing, such as the retrieval portion of retrieval augmented generation (RAG).

Typically, agents are configured to process information using large language models (LLMs), which have been trained on large amounts of data. Although LLMs have many capabilities, the system is configured to not automatically maintain state information for many agents. For example, many agents operate in a stateless mode, where each new set of input is performed independently from prior inputs and outputs. Although the computer system maintains the context of the conversation that the user is having, the individual agents do not each retain and use that context. Instead, the portions of context or the relevant input data is provided to each agent by the computer system that orchestrates and facilitates the processing. The computer system clears the context so each input to an agent contains the full set of input to be processed in that operation. In this way, the agents are not burdened by an increasing amount of context that may not be relevant to the agent’s task and likely would not be relevant to the most recent user query. For example, a language detector agent can detect the language of a user input provided to it, and to perform its function it has no need to examine or retain information about prior user inputs. Limiting the set of input or context for each agent can significantly increase the accuracy by keeping out less relevant information and ensuring that the AI/ML model is attending to the current information relevant to the agent’s function.

The computer system coordinates the exchange of information among agents, to create the input data set provided to each agent and to manage the use of output from each agent. The computer system coordinates the flow of information so that output of agents is selectively shared with other agents. In some implementations, the computer system stores information that defines the overall workflow and multi-stage processing that is performed using the agents. For example, the computer system can store system prompts and system instructions for each agent, data indicating the sequence of processing of the agents (including dependencies among agents or groups of agents), data that defines the type of input and source of input for each agent, and the types of output received by the various agents.

As an example, the computer system can be configured to have a first agent perform first function for processing a query. Based on the workflow of agent processing that the computer system stores, the computer system provides the output of the first agent as one of several inputs to a second agent for performing a second function. The computer system may cause a third agent to perform a third function in parallel with the second agent, based on the workflow structuring the processing of the two agents to not depend on each other. Through the processing and contributions of many agents, activated or invoked by the computer system according to the overall workflow, the computer system can generate a response that ultimately combines the information generated by the various agents by performing their respective functions.

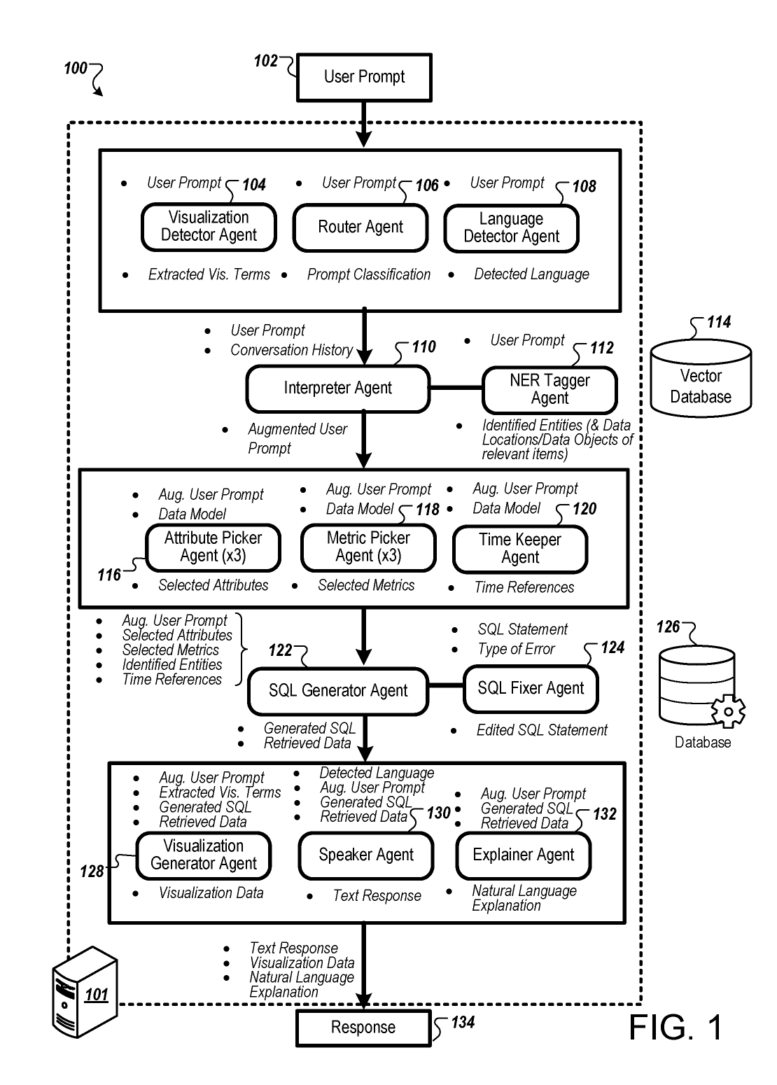

FIG. 1 is a diagram showing an example of a system 100 that uses an agentic architecture for artificial intelligence chatbot processing. The system 100 includes a computer system 101, a vector database 114, and a database 126. The system 100 allows a client device of a user to communicate with the computer system 101, such as to provide queries and receive corresponding responses. The computer system 101 has various agents that it can invoke, in an ordered way, to automatically generate a response to a query through multiple processing steps. In the system 100, each agent performs a corresponding function that is part of interpreting the user’s request and generating the response for the query.

In some implementations, the computer system 101 can provide an interface for client devices and others to communicate with the system. Client devices, applications, and other devices can provide a query, request, or user prompt to the computer system 101 over a network, and the computer system 101 can process the query to generate a response. Subsequently, the computer system 101 can provide the generated response to the client device over the network, for display at the client device. The computer system 101 can allow the user device to submit one or more queries, and submit these queries within a short time frame, such as in a normal conversational style.

The example of FIG. 1 shows a variety of different agents 104, 106, 108, 110, 112, 116, 118, 120, 122, 124, 128, 130, and 132. Each of these can operate in run in parallel, however the processing of a particular user input may involve processing sequentially from one agent to another, e.g., with the output of one agent for a particular user prompt being needed to invoke the next agent and continue processing for that particular user prompt. Each agent is itself stateless, and handles the full set of input to generate a response, then begins with a fresh set of input when it is invoked next. The computer system 101 assigns an identifier (e.g., a user prompt identifier or session identifier) to the processing for each query, so that information for a user prompt is tracked and maintained through the course of interactions among the agents. To improve capacity and throughput of the system to handle many concurrent conversations with different users, the computer system 101 can have multiple copies or instances of each of the various agents. As a result, the computer system 101 can concurrently process user prompts from many different users. For clarity in illustration and explanation, the discussion of processing will follow the processing for a single user prompt. Nevertheless, the same set of techniques can be used to handle many concurrent requests.

Prior to a user submitting a query, the user can interact with a user interface, such as through a web page, a web application, a local application, etc. The user authenticates with the computer system 101, so that the computer system 101 identifies the user and determines the permissions for the user to access different functions or data sets. Different permissions may grant access to different types of data in the vector database 114 or the database 126, or to different agents utilized by the computer system 101. The computer system 101 can enforce access control policies according to the user’s level of authorization. When answering a question on behalf of a user, the computer system 101 can limit an agent’s access (e.g., to data or external tools) on behalf of a user to the data that the user asking the question is authorized to access. Accordingly, the computer system 101 can store and access user lists, user permissions, access control lists, and other data to facilitate authentication and access control.

The computer system 101 can be implemented using one or more servers, such as one or more cloud computing systems, one or more on-premises servers, etc. For example, the computer system 101 can be an application server. The computer system 101 can perform back-end processes and can support front-end processes. For example, the computer system 101 can provide user interface data for a web page, web application, native application, etc. to provide data for display at the client devices.

The database 126 can provide various data retrieval and processing functions. For example, the database 126 can include a database management system (DBMS), and can include the capability to process operations specified in structured query language (SQL), Python code, Java code, or in other formats. For example, the database 126 can include a high-performance, column-oriented SQL DBMS for online analytical processing (OLAP). This allows for the database 126 to be queried against using SQL and other formats. The database 126 stores and has access to various datasets, which may include private or personal datasets for organizational purposes. The database 126 can store and use datasets in any of various forms including tables, data cubes, or other forms.

The vector database 114 can include a vector store or database that can store information in association with vectors in a high-dimensional space to facilitate retrieval. For example, each item stored or indexed using the vector database 114 can have one or more vector embeddings generated based on the item’s content. The items stored can include, for example, values from data sources, metadata or descriptive information about data tables and their data objects (e.g., columns, attributes, metrics, etc.), and other data objects. Because stored items are associated with vector embeddings, semantic search techniques can be used to efficiently retrieve semantically similar items. For example, vector embeddings generated from content of a user’s question can be compared with stored vector embeddings. The stored vector embeddings that are most similar (e.g., have the shortest distance from the question vector embeddings in the vector space) are typically the most relevant to the topics, keywords, and concepts of the user’s question.

In some implementations, the computer system 101 includes a variety of agents. For example, the agents include a visualization detector agent 104, a router agent 106, a language detector agent 108, an interpreter agent 110, a named entity recognition (NER) tagger agent 112, an attributer picker agent 116, a metric picker agent 118, a time keeper agent 120, an SQL generator agent 122, an SQL fixer agent 124, a visualization generator agent 128, a speaker agent 130, and an explainer agent 132. The computer system 101 can include other agents as well. Although the agents act separately, the computer system 101 guides the flow of data and the invocation of the agents so that their various tasks combine to process user prompt 102 received by the computer system 101 to produce a response 134. The user prompt 102 may include a query with a single request or a query with multiple requests, such as a compound question.

The overall order of the chatbot workflow proceeds from top to bottom in FIG. 1. The computer system 101 enables various agents to operate in parallel to improve overall efficiency. For example, when the computer system 101 receives a query or user prompt 102, the visualization detector agent 104, the router agent 106, and the language detector agent 108 each receive the user prompt 102 and separately perform their processing in parallel for that user prompt 102. Later in the workflow, the attribute picker agent 116, the metric picker agent 118, and the time keeper agent 120 operate in parallel to separately process output produced by the interpreter agent 110 for the user prompt 102. Similarly, the visualization generator agent 128, the speaker agent 130, and the explainer agent 132 operate in parallel to produce different types of output data responsive to the user prompt 102. By enabling agents to perform parallel processing, the computer system 101 can reduce overall processing time for responding to the user prompt 102.

In some parts of the workflow, agents work sequentially. The processing of some agents is configured to act on outputs of agents positioned earlier in the workflow. The interpreter agent 110, the NER tagger agent 112, the SQL generator agent 122, and the SQL fixer agent 124 operate in a serial manner, or operate when triggered by another agent or component in the computer system 101.

The agentic approach of the computer system 101 is orchestrated so that agents act in a compartmentalized manner, in which each agent is configured to perform a discrete function or task within the broader processing of the query and generation of the response. This approach avoids overloading each agent by ensuring that each agent operates within a focused scope and is only exposed to the information needed to perform its function. Additionally, by limiting the data provided to each agent, the computer system 101 reduces computational complexity, minimizes undesired cross-agent communication not needed for the agents’ functions, and increases accuracy of output from each agent.

In some implementations, each of the agents in the computer system 101 generates an output based on processing a set of input as specified by the system prompt or system instructions that define the agent’s function or task. The agents can be configured to generate their outputs using a particular data or messaging format, as specified in the system prompt or system instructions. Different agents produce output in different formats, according to their respective functions. For example, the language detector agent 108 may be configured to output a language identifier, which may be a word, a number, or another value. The speaker agent 130 can be configured to produce text, in order to provide text output for presentation to a user. The visualization generator agent 128 can be configured to provide output in a JSON format to specify the content and structure of a visualization.

In some implementations, at least some of the agents, especially agents that are configured to generate output that becomes the input for other agents, are configured to generate output that is structured or is encoded in a format that provides clear annotations to define the elements present, e.g., annotations such as headers, labels, key-value pairs, table structure elements, and list structure elements, and so on. Including the annotations that can demarcate the elements of the output, and in some cases their semantic meaning or interpretation, can greatly increase the likelihood that another agent that receives the output will interpret it and identify the elements correctly, especially compared to unstructured natural language. For example, the messaging format can include Markdown, comma-separated values (CSV), markup language content, or another type of format. Outputs that will be shared from one agent to another can use this messaging format to allow the agents to accurately interpret the message with less room for error or misinterpretation.

By relying on a messaging format that provides structure or markup to the output, the computer system 101 is configured to minimize the number of agents that need to interpret unstructured natural language. In agentic systems where many agents are involved, the more times that different agents need to separately interpret (or re-interpret) natural language text, especially the same natural language text, the more opportunities there are for errors and inconsistencies. Adding annotations or other markup can preserve semantic mappings to better ensure consistent interpretation throughout the agentic pipeline. For example, a markdown format allows for preserving a structured mapping of user terms to data objects and propagates these mappings between agents in an agent-interpretable format that provides high confidence of accurate interpretation. This approach helps avoid information loss and inconsistency that could otherwise arise from burdening each agent with interpretation tasks.

As noted above, the visualization detector agent 104, the router agent 106, and language detector agent 108 each receive the user prompt 102 and operate in parallel to produce their respective outputs for the user prompt 102.

The visualization detector agent 104 can analyze the user prompt 102 to determine whether a visualization is requested or otherwise should be generated in response to the user prompt 102. The visualization detector agent 104, like most or all of the other agents, can represent a module that performs processing using (e.g., sends a request to and receives an output from) an AI/ML model such as an LLM. The visualization detector agent 104, like other agents, can represent an instance of LLM processing using the predetermined system prompt or system instruction for that agent’s function. The text of the user prompt 102 serves as input to the LLM, expressed in tokens or another appropriate form. The system prompt or system instructions from the computer system 101 instruct the visualization detector agent 104 to determine whether a visualization is needed. As discussed below, the system prompt or system instructions can instruct the visualization detector agent 104 extract words from the user prompt 102 that are related to visualizations. The extracted visualization-related words will later be used by the visualization generator agent 128 to determine the type of visualization and perform other processing. In some implementations, the visualization detector agent receives a set of examples or keywords to identify in user prompts that are known to correspond to features of visualizations, which can improve the accuracy of detection and pattern matching.

In some cases, the user prompt 102 may explicitly request for a visualization to be shown, such as, “Show me a bar chart of financial sales between the northeast region and the northwest region in 2024.” Here, the visualization detector agent 104 can analyze the text of the user prompt 102 to detect that “show me” indicates a visualization should be generated and that the user requests a “bar chart” as the type of visualization to be shown in the response. In some cases, the user prompt 102 may be less explicit about a visualization, and the visualization detector agent 104 can infer whether a visualization would be beneficial in responding to the user prompt 102. For example, a user prompt 102 can include “Show me a trend of financial sales between the northeast region and the northwest region in 2024.” In this instance, the visualization detector agent 104 can infer that the phrase “Show me a trend” signals a request for a type of visualization of this data, whether that type of visualization is a line chart, a bar chart, or other visualization type.

The visualization detector agent 104 can extract the text of the user prompt 102 that signals the request for the visualization. For example, the visualization detector agent 104 extracts words such as “show me,” “bar chart,” “line graph,” or “show me a trend” from the user prompt 102, if present. In some implementations, a modified version of the user prompt 102 is then generated, which as the visualization-related words removed, is provided to the interpreter agent 110. For example, after removing visualization-related words, the remaining portion of the user prompt 102 “financial sales between the northeast region and the northwest region in 2024” is provided to the interpreter agent 110. The removal of visualization-related words helps keep the interpreter agent 110 focused on the type of data the user needs, e.g., words that describe dimensions and measures of interest to the user. As another example, the detected visualization-related words can be provided as input to the interpreter agent 110, marked as visualization terms, so the interpreter agent 110 can understand the full user prompt 102 and the interpreter agent 110 itself can remove or change the visualization terms when generating an augmented user prompt. The detected words that signal the request for the visualization, and potentially the visualization type, are extracted and will be provided as input to the visualization generator agent 128, but are not removed from the version of the prompt 102 passed to the interpreter agent 110.

The router agent 106 can analyze the user prompt 102 to determine a prompt classification. In general, different user prompts can call for very different types of responses. Some user prompts can be answered with data from a database, others cannot. The system can have multiple predetermined types of prompt classifications, each representing a different type of user request. The computer system 101 can be configured to perform different processing (e.g., invoking different agents or different paths in the agentic architecture) for different prompt classifications. For example, for some prompt classifications, the computer system 101 may use the full set of agents shown, while for other prompt classifications, the computer system 101 may bypass some or all of the other agents shown to process the user prompt 102 in another way.

The router agent 106 can identify or assess content of the user prompt 102 to determine whether additional processing on the user prompt 102 is required, e.g., performing one or more SQL executions against database 126, responding to a pleasantry indicated in the user prompt 102, or to deny the user prompt 102. The router agent 106 analyzes the text of the user prompt 102 and determines a classification of the user prompt 102, such as a type of query or request made, a type of answer called for, or a type of processing to be performed (e.g., in some cases, a set of agents or series of agents to use in processing and generating a response to the user prompt 102).

The processing of the router agent 106 can include providing text of the user prompt 102 as input to an LLM, and receiving as output a classification of the user prompt 102, e.g., output designating the user prompt 102 as a pleasantry, a general request, a request to retrieve or supply a fact, a request to generate a visualization, a request to generate SQL, or prompt that is not authorized. Based on the determined classification, the router agent 106 can take an additional action or initiate further processing. As an example, if the router agent 106 classifies the user prompt 102 as a pleasantry, then the router agent 106 can route the query to the speaker agent 130 (discussed below) to quickly and efficiently generate a response to the user prompt 102 (such as a response “I am doing well, how is your day” for the user prompt “How are you?”). In this scenario, the system 101 can bypass the agents for data retrieval based on the prompt classification, and quickly and efficiently generate the response. As another example, if the router agent 106 classifies the user prompt 102 as a request to perform SQL generation, then the router agent 106 can provide the text of the user prompt 102 to the interpreter agent 110, to further process the query and fulfill the request. As another example, if the router agent 106 classifies the user prompt 102 as a prompt that is not authorized or outside the ability of the system to answer, then the router agent 106 can ignore or discard the user prompt 102, or supply a basic answer such as “I’m sorry, I can’t help you with that.”

In many cases, user prompts that are classified as types of prompts that the system can answer (e.g., a request for generating a visualization, a request to generate SQL content, a request to retrieve or supply information, a request to analyze a data set, etc.) are handled by next providing the user prompt 102 to the interpreter agent 110, and then to additional agents. As discussed further below, the various agents can be specialized to make different types of determinations about the type of information requested and the source of that information, so that the answer that is ultimately generated fulfills the intent of the user that is expressed in the user prompt 102. The determinations of and outputs of various agents can be provided as input to (or otherwise be part of the context for) other agents, allowing the full meaning and content of the user’s request and the answer to be determined incrementally and retained through the data flow. In many cases, one agent’s determinations can flow through to the next agent (or the next group of agents). By focusing specific agents on discrete tasks that they can complete with high accuracy, which allows the later agents to benefit from the high-confidence determinations of the earlier agents. The result is that the overall answer generation process can be much more accurate than using more generalized agents or having a model attempt to address the user prompt 102 as a whole.

The language detector agent 108 can analyze the user prompt 102 to determine the language of user prompt 102 or detect if the user prompt 102 requests an answer in a particular language. In some cases, the computer system 101 allows prompts to be received in any of various languages, e.g., English, German, or French, etc., and the computer system 101 can detect the language and output an identifier for the language that is provided to other agents (e.g., the visualization generator agent 128, the speaker agent 130, and the explainer agent 132), so that the response is generated in the same language as the user prompt or in the language the user has specified.

In some cases, the computer system 101 receives a user prompt 102 in a first language and detects that the response is to be produced in a second different language from the first language. For example, the user prompt 102 can include “Describe the financial sales in the northeastern region from 2024 in French.” Here, the language detector agent 108 can provide the text of the user prompt 102 as input and receive as output an indicator that the detected language of the user prompt 102 is English and an indicator that the language for a response of the user prompt 102 is French. Consequentially, the computer system 101 propagates an indication of the detected output language to the speaker agent 130, which will be further described below.

After the visualization detector agent 104, the router agent 106, and the language detector agent 108 have completed their processing, the interpreter agent 110 is invoked to continue processing the user prompt 102 in view of the outputs of the first three agents. The interpreter agent 110 can also use information from the named entity recognition (NER) tagger agent 112, which can be invoked in any of various ways. For example, the NER tagger agent can be run first, before invoking the interpreter agent 110, so the interpreter agent 112 can benefit from the entities that are found. As another example, the interpreter agent 110 can itself invoke the NER tagger agent 112 when the interpreter agent 110 detects a reference or a pattern that likely includes a named entity.

The NER tagger agent 112 analyzes the user prompt 102 to identify references to entities (e.g., people, companies, places, etc.). The NER tagger agent 112 can search for entities mentioned in the user prompt 102 in the vector database 114. Items that the NER tagger agent 112 finds, e.g., results that have a measure of similarity or closeness according to vector distance, can be identified and provided as output. The NER tagger agent 112 can be very helpful in disambiguating partial references, misspellings, and other non-standard items. For example, a user prompt 102 may reference “Dr. Jones” but the data set includes only first name and last name data and does not include this particular phrase. Nevertheless, searching the contents of the relevant data set(s) using the vector database 114, the NER tagger agent 112 can find a match to an item “David Jones,” or at least find the last name “Jones” as a value from the data column storing last names. This allows the NER tagger agent 112 to generate output specifying that “Dr. Jones” refers to “David Jones.” In some cases, the NER tagger agent 112 also provides information about the semantic meaning of results found, such as the column or data object of the result (e.g., a customer name attribute column), and potentially where in a data set the result can be found, e.g., the data set, table, column, row, etc.

For example, the NER tagger agent 112 identifies nouns in the user prompt 102 and attempts to match the nouns to terms stored in the vector database 114. The NER tagger agent 112 can determine a query vector embedding for each of the nouns identified, and then use nearest neighbor search or other similarity search techniques to find stored items that are closest in the vector space. Using metadata for results, the NER tagger agent 112 can also identify locations where results from the vector database 114 search are stored in other datasets, such as data cubes, tables, etc., and can identify the type of data or semantic meaning.

In some implementations, the NER tagger agent 112 can attempt to resolve ambiguities if one or more terms from the user prompt 102 match to multiple entities or multiple schema elements in the vector database 114. For example, if the NER tagger agent 112 matches one or more nouns found in the user prompt 102 to multiple tables in the vector database 114 through embedding similarity analysis, e.g., using a RAG technique, then the NER tagger agent 112 can attempt to resolve the ambiguity across the multiple tables. For example, the NER tagger agent 112 generate one or more vector embeddings of the identified nouns in the user prompt 102 and compare those embeddings to embeddings of the identified columns of the multiple tables.

The interpreter agent 110 analyzes a version of the user prompt 102 (e.g., one that excludes the terms extracted by the visualization detector agent 104), along with a prior conversation history for this particular user, to generate an augmented user prompt. The interpreter agent 110 transforms the user prompt 102 into the augmented user prompt, which is often more clear, more complete, and more actionable for downstream agents to process, e.g., agents 116 through 132. Generally, a role of the interpreter agent 110 is to interpret the user prompt 102 to add information that is either implicit, or should be propagated from earlier in the conversation, or is missing from the user prompt 102. By supplementing or augmenting the user prompt 102 with information that was implied or part of the data context, the interpreter agent 110 can normalize the user prompt 102 into a prompt that includes the criteria needed by later agents in the workflow.

As an example, a user may provide a prompt that states “sales 2024.” This, on its own, does not provide the full criteria to retrieve data and answer the question. However, by analyzing the conversation history, the interpreter agent 110 can determine that the discussion involves a particular store in New York City, and so the criteria or context of that store should be imported or propagated to the current user prompt 102. As a result, the interpreter agent 110 can form a query or prompt that is a better, more completely specified question, and includes appropriate context from the conversation history or other sources, e.g., “what are the sales for the New York City store in 2024?” This added information gives the later agents in the workflow needed information to process the query.

If the NER tagger agent 112 has identified a relevant result, the interpreter agent 110 can use the generated relationship (e.g., “Dr. Jones = David Jones”) to augment or replace a vague or ambiguous term with a clearer reference that resolves the ambiguity. For example, if a user prompt is “show me information for Dr. Jones,” and the NER tagger 112 finds a result “David Jones” and the metadata indicates that the result is from a data table listing customers, the interpreter agent 110 can generate an augmented query, “show me information for customer David Jones.” If the information the NER tagger 112 has identified has more information about the named entities, that information can be added as well, such as “show me information for customer David Jones, head of oncology at ABC University.” In some implementations, information about the source of information can be provided also, such as the record, table, or database in which information is found.

In some implementations, the interpreter agent 110 leverages information about the structure of available data sets, such as information in a data model that specifies data sources, data tables, columns, and data objects (e.g., attributes and metrics). Besides listing the various data objects available, the data model can indicate names, descriptions, data types, and other information for the various data objects, so that the interpreter can identify references to different criteria, such as for dimensions (e.g., attributes) and measures (e.g., metrics) and references to them in the user prompt and conversation history.

In some implementations, the interpreter agent 110 is configured to generate the augmented user prompt using more than the conversation history to supplement and disambiguate a user prompt 102. For example, the computer system 101 can receive information about the particular user interface (e.g., web page, web application, native application, etc.) the user is using, and can receive text of that interface or text describing the user interface. As a result, if the user prompt states “extend this graph 2 years in the past,” the user interface information can indicate which graph is being shown to the user, and the interpreter agent 110 can use that information to further define the request. More generally, the information about the state or content of the user interface can specify a task of the user, content selection by the user, a working data set being used by the user, and so on, all of which provide information that the interpreter agent 110 can pull in to add specificity and context in the augmented prompt.

As another example, the interpreter agent 110 can receive as input and can use a knowledge base, semantic graph, or other repository of stored data for the user or the user’s organization. Information from those sources can also be used to add information to the augmented user prompt. As an example, a knowledge base can be provided to assist the computer system 101 in interpreting data sets with the terminology for the user’s organization. In general, the knowledge base can function to provide contextual knowledge, so the interpreter agent 110 (and potentially other agents) can classify and recognize the appropriate nomenclature when evaluating input, especially to later determine associations between terms and data objects. Organizations or departments may use terms that have a special contextual meaning, or are not part of general language, and so would not be available for training of an LLM. For example, a company may internally use various names for its products, projects, teams, locations, policies, initiatives, organizational structure, and so on. For example, a company may be developing a product with a codename that is specific to the company and not referenced in public documents. To enable the AI/ML models to infer relationships between data sets, the knowledge base can be designated to describe these and other internal terms. In some cases, the knowledge base can include definitions for terms, such as the full text corresponding to acronyms, or the formal text corresponding to a nickname. The knowledge base can provide information similar to a semantic graph, by describing entities and their relationships. In some cases, the information in the knowledge base can be derived from a semantic graph and then converted into text (e.g., unstructured, semi-structured, or structured) in a format that can be processed by the LLM.

In general, the knowledge base or other additional data set can include data that maps terms or phrases to their meanings. In many cases, this can include semi-structured data or explanatory content, as a way to explain entities and relationships to the AI/ML models. Although the knowledge base may include definitions, more generally the information may include descriptions of people, roles, business units, products, and other terms that may be referenced. The knowledge base can improve consistency for many data sets used within an organization. Although not illustrated in FIG. 1, the computer system 101 can includes the knowledge base, or specific segments of the knowledge base identified by the NER tagger agent 112 or the interpreter agent 110, in the input or context for other agents to use when interacting with AI/ML models. In addition, the knowledge base provides persistent context that is not lost from one prompt to another or from one session to another. In some implementations, the knowledge base content can also be implemented applied in a manner that the knowledge base does not count toward the instruction token limits that the AI/ML models consume for each response. Rather than counting toward the tokens for prompts and recent history, the knowledge base can be accessed or provided to the AI/ML models as a separate source of knowledge apart from the prompt and context, and so does not count toward the token limits of an LLM. Implementations of access to the knowledge base can vary. In some cases, the knowledge base can be prepared as an embedding, a vector database, or other format that can be accessed by or referred to by the AI/ML models.

After processing of the interpreter agent 110 and the NER tagger agent 112 is complete, the computer system 101 can run the attribute picker agent 116, the metric picker 118, and the time keeper agent 120 in parallel to perform their respective tasks for the user prompt 102. Each of these agents 116, 118, and 120 receives the augmented user prompt and a data model describing the available data objects in one or more data sets (e.g., databases or other data sources). The data model can be generated in advance, such as when a data set is processed for later use by a chatbot system. As discussed further below, multiple instances of the attribute picker agent 116 and the metric picker 118 can run in parallel, each with the same set of input (and the same AI/ML model and system instructions) and each generating its own set of output, which may vary from one instance to another. Then, the outputs of the different instances can be combined to improve accuracy and repeatability.

The data model can include information about the data set(s) that the chatbot will use to respond to the request. For example, the data model can include a data schema for the data set. In general, the data model can indicate a list of logical objects represented in the data set, such as a list of the elements or components of the data set, such as metrics, attributes, facts, and so on. For example, the data model can indicate that the data set includes logical objects such as date, customer identifier, region code, sales amount, and so on. These data objects can represent quantities or data objects that are represented in, or can be derived from, data in the data set. The logical objects, such as metrics or attributes, can represent the type of data that is stored in or derived from a column of data. For example, an attribute may represent a type of data stored in a column of a data table or the result that would be obtained by applying a particular arithmetic expression to data in a column. Similarly, a metric or fact can represent the result of applying a particular aggregation function or other operation(s) to values in one or more columns of a data table. Accordingly, the data model can indicate the attributes and metrics that are available for the AI/ML model to work with, and potentially additional attributes or metrics that can be generated or operations that are available for the database system to create a new attributes or metrics.

In some cases, the data model can indicate, through the logical objects it lists, data from tables, columns, and other elements that make up the data set, in addition to or instead of the semantic meanings and/or relationships among these elements of the data set. For example, the data model can indicate that the data set includes set of data named “sales_table,” that includes a metric named “sales_amount” that indicates amounts of sales and another attribute named “region” that indicates the region in which the sale occurred. These quantities may or may not correspond directly to the structure of the data set. For example, the item “sales_table” may be an actual data table of a database, or may not represent a table and instead another grouping of data. Similarly, the “sales_amount” and “region” objects may correspond to specific columns of a data table, but may alternatively represent values that can be calculated or otherwise derived from the data set in another way. Providing the data model can give the AI/ML model a list and description of the logical objects that the database system recognizes, so that code or instructions generated by the AI/ML model can use the identifiers known to the database system and/or the computer system. As a result, the AI/ML model can generate code or instructions that reference these logical objects that are understood by the computer system and the database system. To the extent that the objects indicated in the data model differ from the actual structure of the data set, the computer system and the database system can use convert from the logical object names used in the data model to actual data set elements and functions.

The data model can indicate the names or labels for these data elements, classifications of the elements (e.g., metric, attribute, etc.), and other information. In some implementations, the data model can include sample data for the data set, such as a sampling of data from the data set. The sample data can be fictitious example data that may be artificially synthesized to be representative of the data in the data set (e.g., similar types of data), without indicating actual contents of the data set. The data model can be provided in any of various forms, such as a database schema from a database management system, a list or definitions of objects, components, or identifiers of the data set, etc.

By providing the data model with the requests to agents, the computer system 101 provides an agent (and the AI/ML model it invokes) the ability to make use of the logical objects specified in the data model. As a result, the AI/ML model can determine the types of data that would be available from the data set, even without the AI/ML model having any access to the data set. The AI/ML model can generate code or instructions (e.g., a SQL statement) that references these logical objects, with a clear set of names or other identifiers to accurately and unambiguously reference components of the data set. For example, providing the data model for the data set, may enable the AI/ML model to identify or reference logical objects in generated SQL statements that the computer system 101 and/or database 126 can unambiguously map the logical objects to tables and columns of the data set. This allows the AI/ML model to distinctly and unambiguously define criteria to specify the subset or portion of data to be retrieved from, or calculated based on, the data set.

The attribute picker agent 116 can analyze the augmented user prompt with the data model to select relevant attributes of the data model. Generally, the computer system 101 instructs the attribute picker agent 116 to select attributes from the data model that it determines to be relevant to the augmented user prompt. For example, if a user prompt includes “last year,” the attribute picker agent 116 can select a “year” column defined by the data model, or a “date” column defined by the data model. The attribute picker agent 116 selects attributes that can later be used in a SQL query for querying the database 126, either for displaying, filtering, grouping, aggregating, or other. The attribute picker agent 116 can select specific attributes to correspond to specific terms or phrases in the augmented user prompt. The attribute picker agent 116 can also specify a level of confidence in the selections, as well as specify whether terms and phrases are identified as not corresponding to any attributes.

For example, the attribute picker agent 116 can use LLM processing to determine whether to select attributes from the data model for terms in the augmented user prompt, and which attributes have the appropriate type of data, according to the text in the augmented user prompt 102. In particular, the input to the LLM can be the data model and the augmented user prompt. As an alternative, the input can be the data model and nouns or noun phrases extracted from the augmented user prompt. The LLM can evaluate a similarity of the extracted nouns to the names and descriptions of attributes defined in the data model and determine relationships between the extracted nouns to the data in the data model. Based on the relationships, the LLM can output selected attributes (e.g., attribute names or identifiers, column names or identifiers, etc.) from the data model whose similarity exceeds a threshold or criteria. In effect, the attribute picker agent 116 can map elements of the augmented user query to attributes defined in the data model. The output can specify the word or phrase from the augmented query that is mapped to each selected attribute, e.g., “[year = Sales_Year], [home = Customer_Address]” The computer system 101 can later provide the selected attributes, and the data indicating the mapping to test of the augmented user query, to the SQL generator agent 122 for generating SQL statements for retrieving data from the database 126 to answer the user prompt 102.

The computer system 101 executes or invokes the attribute picker agent 116 multiple times, with instances running in parallel, using the same input information each time. For example, the computer system 101 executes the processes of the attribute picker agent 116 three, four, or five times using the same input information, e.g., the augmented user prompt and the data model. Due to the non-deterministic nature of LLMs and many other AI/ML models, the same LLM may produce a different response in response to the same question and context. For example, the temperature setting of a LLM may cause it to sometimes select to generate output that is not the most likely or best choice during a given round of processing, and sometimes this results in hallucinations and inaccurate responses. To ensure that the attribute picker agent 116 receives accurate results from the LLM, multiple instances of the attribute picker agent 116 can execute concurrently, to produce multiple outputs, e.g., multiple sets of selected attributes or multiple mappings of terms to attributes. In some cases, the LLM may produce different selected attributes during each execution or instance of processing. The computer system 101 can then combine the results from the multiple processing runs, for example, rejecting outliers and keeping attributes that are consistently selected by two or more of the processing instances. By compensating for the non-deterministic nature of LLMs to provide somewhat different answers to the same question, the overall accuracy of attributes selected can be improved. The attributes selected, along with the metrics selected, are important factors in accurately defining the criteria for selecting data from the database 126, and so the improved accuracy of running multiple instances is worth the processing cost.

The metric picker agent 118 can analyze the augmented user prompt (or nouns or noun phrases extracted from the augmented user prompt) with the data model to select relevant metrics defined in the data model. Generally, the computer system 101 instructs the metric picker agent 118 to select metrics from the data model that it determines are relevant to terms or phrases in the augmented user prompt. The metric picker agent 118 selects the metrics to be included in a query for querying the database 126, either for displaying, filtering, grouping, aggregating, or other.

For instance, the metric picker agent 118 performs processing with an LLM to determine whether to select a metric from the data model, and determines which metrics to select, according to the text in the user prompt 102. In particular, the metric picker agent 118 can provide, as input to the LLM, the extracted nouns from the augmented user prompt and the data model. The LLM can evaluate a similarity of the extracted nouns to the names, labels, or descriptions of metrics in the data model and determine relationships between the extracted nouns to the data in the data model. Based on the relationships, the LLM can output the metric from the data model that best fits various terms or phrases. For example, for a phrase “money earned” the LLM can identify a column “Revenue” from the data model, and can provide output that maps the two together, e.g., “[money earned = Revenue].” The references to metrics can be made using the metric names or identifiers, or column names or identifiers, from the data model so that other agents, such as the SQL generator 122 can identify the correct metric. The computer system 101 can use the output from the data model as selected metrics to provide to the SQL generator agent 122.

Similar to the attribute picker agent 116, the computer system 101 executes the metric picker agent 118 a set number of times, with instances running in parallel, using the same input information each time. For example, the computer system 101 executes the processes of the metric picker agent 118 three, four, or five times using the same input information, e.g., the augmented user prompt and the data model to catch outputs if the LLM hallucinates and produces inaccurate responses. In the example, to assist in producing accurate results, the metric picker agent 118 can execute three times, providing the augmented user prompt and the data model to the LLM three times. In some cases, the LLM may produce different selected metrics during each execution. If there is a discrepancy in the mapping between terms and metrics, the computer system 101 can select the mapping that is confirmed by the most processing instances. The computer system 101 can combine the outputs from the different executions of the metric picker agent 118 to reject outliers and compensate for the non-deterministic nature of LLMs that can result in somewhat different answers to the same question.

The time keeper agent 120 can analyze the augmented user prompt and the data model to identify time references. For instance, the time keeper agent 120 can detect temporal expressions from the augmented user prompt. These can include, for example, “for 2024”, “for 2023”, “for Q1 2023”, “last week”, “last month” or “yesterday”, to name a few examples. In some cases, the time keeper agent 120 processing can involve a LLM receiving the augmented user prompt and request for the temporal expressions from the augmented user prompt.

In order to determine specific, well-formed time expressions from time-related text, the time keeper agent 120 can receive input of a current date and time and uses that information to convert relative temporal expressions to absolute (e.g., non-relative) time expressions. For example, if the time keeper agent 120 detects a temporal expression of “the past 30 days”, the time keeper agent 120 can receive a current date and time, e.g., Jan. 31, 2025, then the time keeper agent 120 determines the absolute or non-relative time expression to be Jan. 1, 2025, to Jan. 31, 2025. In some cases, the time keeper agent 120 can analyze the data from the data model to identify references to date or time identifiers. These date or time identifiers can be included in the column descriptions or table description, for example. In response, the time keeper agent 120 can provide the generated time expressions and the columns or tables identified from the data model to the SQL generator agent 122.

The SQL generator agent 122 can generate a query to be used to retrieve data from the database 126, based on input that includes output from one or more upstream agents (e.g., agents that are invoked earlier in the workflow). For example, the SQL generator agent 122 can generate a query, e.g., an SQL query, or other code or instructions for retrieving or processing data, using the output provided by the upstream agents. The upstream agents include, for example, the visualization detector agent 104, the router agent 106, the language detector agent 108, the interpreter agent 110, the NER tagger agent 112, the attribute picker agent 116, the metric picker agent 118, and the time keeper agent 120.

In particular, by the point in the workflow that the computer system 101 invokes the SQL generator agent 122, the functions or tasks of the earlier-invoked agents have already defined many important types of information needed to generate a SQL query. For example, the interpreter agent 110 has incorporated prior history and implicit context into the augmented user prompt, the attribute picker agent 116 and the metric picker agent 118 have identified mappings of terms to data objects (e.g., columns of data), and the time keeper 120 has identified the time references. With this information, much of the information needed to define the type of data to retrieve has been set, and the SQL generator agent 122 can focus on taking the identified data objects and specifying the relationships needed, e.g., which of the already-identified data objects should be used in filters or aggregation parameters, and what values for ranges or thresholds should be.

The output from the upstream agents includes, for example, the augmented user prompt, selected attributes, selected metrics, identified entities from the data model, and the time references. Using this output information, the SQL generator agent 122 combines the structured outputs into a syntactically correct SQL query. The generated SQL query represents a structured expression of the intent and context provided by the user in the user prompt 102, as determined by the agents working together. The generated SQL query is created using column identifiers or data object references that are known and validated against the data model or database schema for the database 126. By referencing the verified table and column names, the SQL generator agent 122 can ensure that the generated SQL will conform to the schema structure of the database 126. Generating the SQL in this manner ensures that upon execution of the SQL against the database 126, the SQL generator agent 122 can provide accurate, relevant results.

The processing of the SQL generator agent 122 includes processing of an LLM to generate an SQL statement. The LLM can generate the SQL using the provided inputs, attempt to correct any potential logical errors it identifies in processing, and provide a logical explanation as to how it arrived at the generated SQL.

In response to generating the SQL statement, the SQL generator agent 122 can cause the generated SQL to be processed by a database system to retrieve information from the database 126. The result of the execution of the SQL statement can include values that represent data that can answer the user prompt 102. The retrieved data can be provided to the downstream agents for further processing.

In some implementations, the execution of the SQL can result in an error, such as a syntax error or an execution error. If the SQL generator agent 122 detects at least one the syntax or execution error (or another type of error), the SQL generator agent 122 can provide the generated SQL statement and the type of error (e.g., an error message) to the SQL fixer agent 124. The SQL fixer agent 124 is a self-correction component in the agentic system that is activated or triggered when the execution of the SQL statement fails. The SQL fixer agent 124 can attempt repair or rewrite the generated SQL statement based the error information.

For example, the LLM processing of the SQL fixer agent 124 can attempt to rephrase or regenerate the SQL statement to avoid the error that occurred. In some examples, if the SQL fixer agent 124 determines the error is a syntactical error, then the SQL fixer agent 124 can attempt to fix the generated SQL statement, often using information about the structure of the database 126 or the content of the data model. In some examples, if the error is determined to be an execution error, then the SQL fixer agent 124 may attempt to re-run the SQL statement to confirm that a reference, such as a column or data object, is incorrect.

The SQL fixer agent 124 can revise the SQL statement and return the revised statement to the SQL generator agent 122 to run, in a further attempt to retrieve the needed data from the database 126. The SQL generator agent 122 can then re-run the revised SQL statement against the database 126. If the revised query successfully produces valid results and not an empty set, then then the revised SQL statement and the valid results are then provided to the downstream agents, e.g., agents 128 through 132. If the revised query fails, then the computer system 101 may take an additional step of notifying the user that submitted the user prompt 102 that this data does not exist or notify the user of an error. In some cases, the error information can be propagated up another layer in the agentic workflow, such as to have the attribute picker agent 116 and/or metric picker agent 118 determine new mappings to data objects.

The final group of agents in the workflow includes the visualization generator agent 128, the speaker agent 130, and the explainer agent 132. These agents operate concurrently to generate different types of output information. Each of these agents receives the results retrieved from the database 126, as well as other types of input.

The visualization generator agent 128 has the function to determine whether a visualization should be produced in response to the user prompt 102, as well as to generate the visualization parameters and data series for a visualization if appropriate. The visualization generator agent 128 can receive the augmented user prompt, the generated SQL, the retrieved data, and the extracted visualization terms from the visualization detector agent 104. For example, the visualization generator agent 128 can analyze the extracted visualization terms to determine whether the user explicitly requested for a visualization, infer whether the user requested for a visualization, or determine whether the user did not request for a visualization. In some cases, the extracted visualization terms may indicate that the user explicitly requested a bar chart, a line chart, or other type of visualization. In some cases, the extracted visualization terms may indicate that the user wants to see a trend or a forecast, which can signal the creation of a visualization. In some cases, the extracted visualization terms may be empty, signaling no visualization is to be shown. In some cases, the visualization generator agent may determine from the augmented user prompt that a visualization is to be shown, even if the extracted visualization terms are empty.

The visualization generator agent 128 can determine an appropriate chart or visualization type based on the provided input. The visualization generator agent can analyze the structure of the generated SQL from the SQL generator agent 122 to identify a dimension (e.g., attributes) that can be represented as an independent variable (e.g., along an X-axis or horizontal axis), and measures (e.g., metrics) that can be represented as dependent variables (e.g., along a Y-axis or vertical axis). In some cases, the system prompt or system instruction to the visualization generator agent 128 can include rules, examples, criteria, etc. to guide the selection of a visualization type or other parameters. For example, the system prompt or system instructions can specify different visualization types that are appropriate for different numbers of attributes and metrics, different dimensions such as time, geography, and so on.

In some implementations, the visualization generator agent 128 can generate a data file that specifies the properties of the generated visualization, and in some cases includes the values and labels of the data series to be illustrated. The data file can include, for example, a data representation of the information to be shown in the visualization, e.g., the attributes, the metrics, and values, in tabular format. For example, the data file can include a JavaScript Object Notation (JSON) format. The JSON is an editable file that is easily read for generating visualizations. The visualization generator agent 128 can provide as output the data file to be visually rendered by a subsequent rendering application.

The speaker agent 130 is configured to generate a natural language response to the user prompt 102. The natural language response includes a narrative description that summarizes the results of executed SQL query. The narrative description can include statistical results, time-based results, comparisons, or other information requested for in the user prompt 102. In some cases, the speaker agent 130 can adjust a tone, personality, verbosity, or formatting of the narrative description according to a user profile of a user that submitted the user prompt 102. In some cases, the speaker agent 130 can produce the narrative description in an auditory manner for auditory based interfaces. In some cases, the speaker agent 130 can translate the narrative description into the detected language based on output from the language detector agent 108.

The speaker agent 130 can receive the augmented user prompt, the generated SQL, and the retrieved data and use an LLM to produce a text response as a narrative description. The system prompt or system instruction of the speaker agent 130 can instruct the speaker agent 130 to generate a natural language response that answers the user’s question or provides the information requested. In some cases, the speaker agent 130 can provide the natural language explanation retrieved from the explainer agent 132 as output to the user.

The explainer agent 132 can generate a natural language explanation of the operations performed to produce the text response from the user prompt 102. Often, this includes an explanation of the generated SQL statement used to generate the data that was used to generate the response. The explanation can include a trace or data flow that describes how data moved through the different agents and the processes performed by the different agents to arrive at the text response. This can include, for example, querying logic performed by the SQL generator agent, time recognized by the time keeper agent, attributes and metrics recognized by the attribute picker agent and the metric picker agent, respectively, an identification of selected tables and columns from the database 126, filtering criteria of the database 126, aggregation strategies, and join conditions. With this information, the user can have confidence in the source of the data and its meaning, and if there are problems, the user can see where the interpretation may have differed from what was expected.

In some implementations, the computer system 101 can output the response 134 to the user prompt 102, e.g., by sending it over a communication network such as the Internet to a client device for presentation to the user. The response 134 can include the visualization data generated by the visualization generator agent 128, the text response generated by the speaker agent 130, and the natural language explanation generated by the explainer agent 132. The response 134 can be provided in textual format, auditory format, or a combination of both. The computer system 101 can display the response 134 on a graphical user interface of a client device that submitted the user prompt 102 or a separate client device.

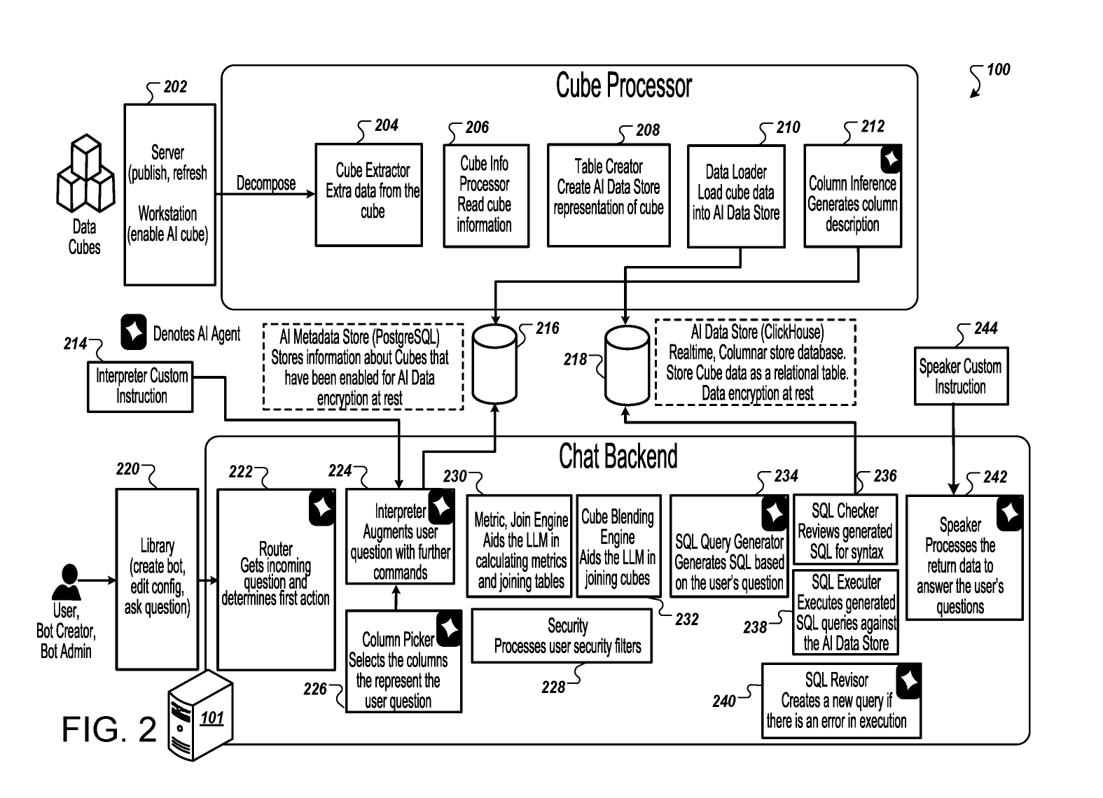

FIG. 2 is a diagram showing an architecture of a data processing pipeline for the system 100 for interacting with the agents and the AI/ML models. The example shows in greater detail an example of components that can be used in conjunction with the agents of the computer system 101 discussed in FIG. 1. The example shows that the computer system 101 can be implemented, in some cases, as multiple servers or modules.

In some implementations, a server 202 receives data cubes from one or more external sources. The data cubes, or multidimensional OLAP cubes, are decomposed by the server 202 into various components, e.g., dimensions, values, and metadata, to name some examples. The server 202 decomposes the OLAP cubes into more manageable components of the cube elements by the downstream engines and agents.

The server 202 provides the decomposed cube elements to a cube extractor 204. The cube extractor 204 extracts data from the cube, such as each of its individual dimensions. The cube information processor 206 reads the cube information from the cube extractor 204 and provides the read cube information to a table creator 208. In some implementations, the table creator 208 can generate an artificial intelligence (AI) data store. The generated AI data store can be suitable for ingestion into a database, e.g., the database 126 or the vector database 114. Accordingly, the generated AI data store can support vector-based, embedding based, or SQL based queries.

In some implementations, the table creator 208 can transform the AI data store information flattened or relational-style table for storage and later retrieval. This information can be subsequently stored in the AI data store 218. The AI data store 218 corresponds to the database 126 shown in FIG. 1. For example, the data loader 210 can load the AI data store with the extracted data from the cube information processor 206. The data loader can map the dimensionality data from the cube to the schema defined by the AI data store.

In some implementations, the column inference agent 212 can generate column descriptions for each column produced by the table creator 208. The generated column descriptions can include human-readable description for each column, and to be used by the agents shown in the chat backend. The column inference agent 212 may utilize an LLM to process the column data and to produce a human-readable column description. These descriptions can be based on the column data contents, metadata of the column, and relationships between the data in the columns. The column inference agent 212 can store the column descriptions in the AI metadata store 216. The AI metadata store 216 corresponds to the vector database 114 shown in FIG. 1.

In some implementations, the system 100 performs various processing features for responding to a query or user prompt provided by a user, a bot creator, or a bot administrator. These processing features include similar features shown in FIG. 1, which are not described again here. A library application 220 represents the system or interface that first receives the query or user prompt issued by the user device. The library application 220 routes the request to a router 222. The router 222 includes the visualization detector agent 104, the router agent 106, and the language detector agent 108.

The output of the router 222 is provided to an interpreter 224. The interpreter 224, which can represent an instance of the interpreter agent 110, seeks augment the user prompt with further commands, instructions, or criteria. The interpreter 224 can augment the user prompt using selected columns provided by the column picker 226. The column picker 226 can represent instances of the attribute picker agent 116 and metric picker agent 118 discussed above. This represents a potential variation to the overall data flow shown in FIG. 1. For example, the selections or mappings from the agents 116, 118, and 120 can be optionally fed back as input to the interpreter agent 110 to further improve or enhance the augmented user prompt that is used by other agents. Data from the selected columns is retrieved from the AI metadata store 216 or the vector database 114, such as from column descriptions from decomposed OLAP cubes.

In some implementations, the metric and join engine 230 assists an LLM in selecting appropriate joins across various columns of different tables according to content of the user prompt. The metric and join engine 230 selects various attributes, metrics, and time references using the attribute picker agent 116, the metric picker agent 118, and the time keeper agent 120. Additionally, the chat backend includes a security engine. The security engine reveals permissions according to the identified user that submitted the user prompt and grants corresponding permissions to the agents for accessing the AI metadata store 216 and the AI data store 218.

In some implementations, the blending engine 232 is configured to integrate data across multiple decomposed tables. The blending engine 232 generates one or more common expression tables. The one or more common expression tables include joins on various disparate tables from the AI metadata store 216. The blending engine 232 generates the one or more common expression tables by joining together tables according to the content included in the user prompt. In response, the blending engine 232 provides the one or more common expression tables to the SQL query generator 234. The SQL query generator 234 is similar to the SQL generator agent 122.

In some implementations, the SQL query generator 234 can verify the accuracy of a generated SQL statement with the SQL checker 236 before executing the generated SQL with the AI data store 218. The SQL checker 236 can analyze the generated SQL to check for syntax errors and semantic validation. If the SQL checker 236 passes the generated SQL, then the SQL executer engine 238 executes the generated SQL against the AI data store 218. If the execution of the generated SQL against the AI data store 218 fails, then the SQL revisor 240 is invoked to correct or revise the generated SQL. The SQL revisor 240 corresponds to the SQL fixer agent 124.

If the results from the SQL executer engine 238 are valid, then the speaker 242 formats the structured response into a natural language response to provide to the user. The speaker 242 can represent instances of the visualization generator agent 128, the speaker agent 130, and the explainer agent 132. The speaker 242 can also provide a visualization output if the chat backend determines whether the user requested a visualization. In some cases, the speaker 242 can receive a speaker custom instruction 244, that indicates whether the speaker should generate audible output, textual output, or other kinds of output.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

1. A method performed by one or more computers, the method comprising:
receiving, by the one or more computers, text input from a user;
in response to receiving the text input, processing, by the one or more computers, the text input using a set of multiple processing actions that each involve processing by one or more artificial intelligence and/or machine learning (AI/ML) models, wherein the set of multiple processing actions includes:
generating an augmented text input based on additional context for the text input;
identifying one or more data objects of a data set based on the augmented text input;
generating code or instructions for retrieving data from a data set based on the augmented user prompt; and
generating output based on the augmented text input and data retrieved from the data set using the generated code or instructions; and
sending, by the one or more computers, the generated output as a response to the text input.

2. The method of claim 1, further comprising providing a chatbot interface, wherein the text input from the user is a user prompt provided through the chatbot interface.

3. The method of claim 1, wherein the one or more AI/ML models comprise one or more large language models.

4. The method of claim 1, wherein each of the multiple processing actions is performed by a different agent, wherein the agents have different system prompts that direct the agents to respectively perform different tasks.

5. The method of claim 4, wherein at least some of the agents are configured to have different output formats or different context for performing their respective tasks.

6. The method of claim 1, wherein generating the augmented text input based on additional context for the text input comprises generating the augmented text input based on at least one of:
a conversation history for a conversation that includes the text input;
a knowledge base for the user or an organization associated with the user;
a set of preferences for the user or an interaction history for the user;
information in a user interface in which the text input was provided; or
one or more entities named in the user prompt.

7. The method of claim 1, wherein identifying the one or more data objects comprises identifying, from a set of data objects specified by a data model for the data set, one or more data objects that correspond to one or more terms in the text input.

8. The method of claim 1, wherein identifying the one or more data objects comprises evaluating the augmented text input using multiple agents that are each configured to identify different types or categories of data objects, wherein the multiple agents are configured to operate in parallel to with each examining the text input or the enhance text input to detect references to its corresponding type or category of data object.

9. The method of claim 8, comprising:
for at least a particular type or category of data objects, performing processing for the augmented text input using multiple instances of the agent for the particular type or category of data objects, wherein the multiple instances of the agent for the particular type or category of data objects operate in parallel to identify data objects of the particular type or category based on the augmented text input; and
selecting, for the augmented text input, one or more data objects of the particular type or category based on the output of the multiple instances of the agent for the particular type or category.

10. The method of claim 1, wherein generating output based on the augmented text input and data retrieved from the data set using the generated code or instructions comprises:
generating output based on the augmented text input and data retrieved from the data set using each of a plurality of agents that are each configured to generate a different type of output content, wherein the agents are configured to operate in parallel to generate output in response to receiving the text input; and
combining output of the multiple different agents, such that the generated output provided as the response to the text input comprises generated output from multiple of the plurality of agents.

11. A system comprising:
one or more computers; and
one or more computer-readable media storing instructions that are operable, when executed by the one or more computers, to cause the one or more computers to perform operations comprising:
receiving, by the one or more computers, text input from a user;
in response to receiving the text input, processing, by the one or more computers, the text input using a set of multiple processing actions that each involve processing by one or more artificial intelligence and/or machine learning (AI/ML) models, wherein the set of multiple processing actions includes:
generating an augmented text input based on additional context for the text input;
identifying one or more data objects of a data set based on the augmented text input;
generating code or instructions for retrieving data from a data set based on the augmented user prompt; and
generating output based on the augmented text input and data retrieved from the data set using the generated code or instructions; and
sending, by the one or more computers, the generated output as a response to the text input.

12. The system of claim 11, wherein the operations further comprise providing a chatbot interface, wherein the text input from the user is a user prompt provided through the chatbot interface.

13. The system of claim 11, wherein the one or more AI/ML models comprise one or more large language models.

14. The system of claim 11, wherein each of the multiple processing actions is performed by a different agent, wherein the agents have different system prompts that direct the agents to respectively perform different tasks.

15. The system of claim 14, wherein at least some of the agents are configured to have different output formats or different context for performing their respective tasks.

16. One or more non-transitory computer-readable media storing instructions that are operable, when executed by the one or more computers, to cause the one or more computers to perform operations comprising:
receiving, by the one or more computers, text input from a user;
in response to receiving the text input, processing, by the one or more computers, the text input using a set of multiple processing actions that each involve processing by one or more artificial intelligence and/or machine learning (AI/ML) models, wherein the set of multiple processing actions includes:
generating an augmented text input based on additional context for the text input;
identifying one or more data objects of a data set based on the augmented text input;
generating code or instructions for retrieving data from a data set based on the augmented user prompt; and
generating output based on the augmented text input and data retrieved from the data set using the generated code or instructions; and
sending, by the one or more computers, the generated output as a response to the text input.

17. The one or more non-transitory computer-readable media of claim 16, wherein the operations further comprise providing a chatbot interface, wherein the text input from the user is a user prompt provided through the chatbot interface.

18. The one or more non-transitory computer-readable media of claim 16, wherein the one or more AI/ML models comprise one or more large language models.

19. The one or more non-transitory computer-readable media of claim 16, wherein each of the multiple processing actions is performed by a different agent, wherein the agents have different system prompts that direct the agents to respectively perform different tasks.

20. The one or more non-transitory computer-readable media of claim 16, wherein at least some of the agents are configured to have different output formats or different context for performing their respective tasks.
